(19) United States
(12) Patent Application Publication
(10) Pub. No.: US 2008/0211223 A1
(43) Pub. Date: Sep. 4, 2008

(54) Notepad holder

(76) Inventor: Kaz Kuroki, Saint Louis Park, MN (US)

Correspondence Address: Roger L. Belfay, 829 Tuscarora Avenue, Saint Paul, MN, 55102, US

(21) Appl. No.: 11/713,294

(22) Filed: Mar. 2, 2007

(51) Int. Cl. B42D 17/00

(52) U.S. Cl. 281/44

(57) ABSTRACT

The notepad holder has a base, a first edge, and a second edge with a stop attached to the second edge to prevent a notepad, placed on the base, from extending past the second edge of the base. The notepad holder has at least one guide pin attached to the first edge.

The notepad holder has a base, a first edge, and a second edge with a stop attached to the second edge of the base to prevent a notepad, placed on the base, from extending past said second edge of said base and at least one guide pin adjacent to the first edge of the base wherein the guide pin or guide pins are placed to retain the notepad in cooperation with the stop for all orientations of the notepad holder within a gravitational or other force field.

### CROSS REFERENCE TO RELATED APPLICATIONS

There are no applications related to this application.

### STATEMENT REGARDING FEDERAL SPONSORSHIP

No invention claimed in this application was made under Federally sponsored research or development.

### BACKGROUND OF INVENTION

Holding a supply of note sheets, a notepad, in a position for use by a user in a broad variety of orientations relative to the force of gravity has been the object of a number of inventions. Historically there have been a number of approaches to this problem.

The utility patent to Rodebaugh et al (U.S. Pat. No. 4,105,224) is typical of a class of inventions in which adhesives or otherwise specially designed notepads are employed.

The utility patents to Ohlson (U.S. Pat. No. 4,518,080) and Sugarman et al (U.S. Pat. No. 4,964,519) are typical of a class of inventions which retain a pad or single card by enveloping the pad or sheets.

The utility patent to Brinker (U.S. Pat. No. 5,025,919) is typical of the large class of notepad holders which do not retain a notepad when inverted or oriented such that the weight of the note pad would tend to dislodge the note sheets or notepad from the holder.

The utility patent to Ho (U.S. Pat. No. 6,102,199) is typical of a class of inventions which require that a notepad be used and that the notepad used include a backer which must be attached at the top of the notepad inserted through a slot in the device.

The present invention provides a notepad which retains a supply of writing paper when oriented in a large range of orientations relative to the force of gravity without employing the above strategies.

### BRIEF SUMMARY OF THE INVENTION

The notepad holder is a device for holding a notepad. Said notepad holder has a base, a first edge, and a second edge with a stop attached to the second edge of the base to prevent a notepad, placed on the base, from extending past said second edge of said base and at least one guide pin adjacent to the first edge of the base wherein the guide pin or guide pins are placed to retain the notepad in cooperation with the stop for all orientations of the notepad holder within a gravitational or other force field.

In some embodiments, one edge of the notepad is grooved to accommodate the guide pins and thereby enhance the ability of the notepad holder to retain the notepad.

### BRIEF DESCRIPTION OF THE DRAWINGS

FIG. 1 is perspective view of the notepad holder.

FIG. 2 is a perspective view of a notepad.

FIG. 3 is a first embodiment of the notepad holder.

FIG. 4 is a second embodiment of the notepad holder.

FIG. 5 is a third embodiment of the notepad holder.

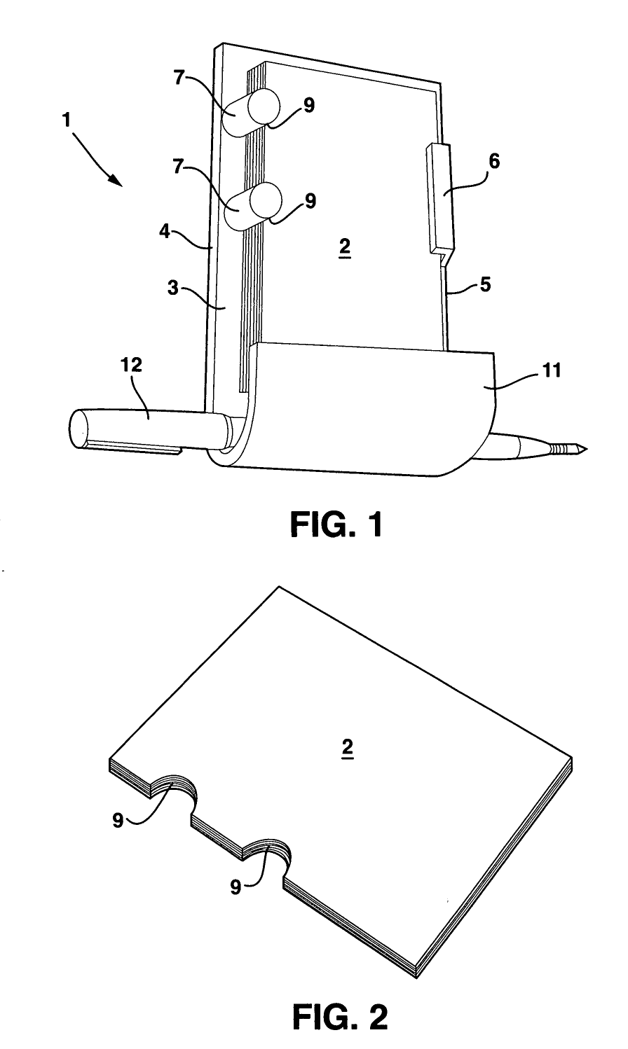

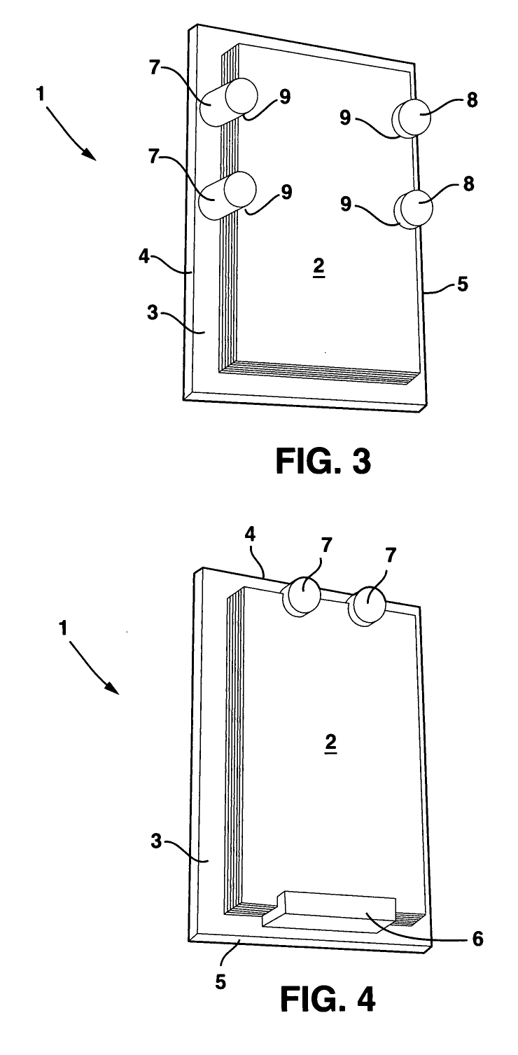

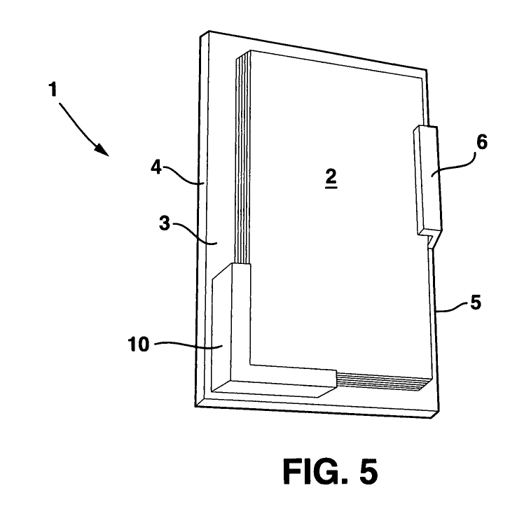

### DETAILED DESCRIPTION

The notepad holder 1 is a device for holding a notepad 2. Said notepad holder 1 has a base 3, a first edge 4, and a second edge 5 with a stop 6 attached to the second edge 5 of the base 3 to prevent a notepad 2, placed on the base 3, from extending past said second edge 5 of said base 3 and at least one guide pin 7 adjacent to the first edge 4 of the base 3 wherein the guide pin 7 or guide pins 7 are placed to retain the notepad 2 in cooperation with the stop 6 for all orientations of the notepad holder 1 within a gravitational or other force field.

In some embodiments, one edge of the notepad 2 is grooved 9 to accommodate the guide pins 7 and thereby enhance the ability of the notepad holder 1 to retain the notepad 2. It will be appreciated that in a number of embodiments there will be one guide pin 7 while in others two or more guide pins 7 may be employed. It will be further appreciated that the stop 6 may be comprised of additional guide pins 8. The additional guide pins 8 may be the same or different than the guide pins 7 which are used in cooperation with the stop 6. In some embodiments the stop 6 and guide pin(s) 7 may be positioned above and below the notepad 2.

Where there are two or more guide pins 7 any number of the guide pins 7 may be implemented from a single element 10 so long as the guide pins 7 are positioned to retain the notepad 2 on the notepad holder 1.

Guide pins 7 may be of any cross section that is suitable to retain the notepad 2 on the notepad holder 1. Guide pins 7 are made of a material sufficiently resilient to hold the notepad 2 in place without damaging the notepad 2. However, the cross section and material selection of the guide pins 7 is chosen for esthetic reasons so long as the guide pins 7 serve to retain the notepad 2.

In some cases the guide pins 7 and additional guide pins 8 are each made of a single element 10. In one such embodiment a pair of guide pins 7 is formed from a single U-shaped element 11 and sized to permit placement and retention of a pen or other writing implement 12 on the notepad 2 and notepad holder 1.

I claim:

1) A notepad holder comprising:
a) a base having a first edge and a second edge;
b) a stop attached to the second edge of the base to prevent a notepad, placed on the base, from extending past said second edge of said base; and
c) at least one guide pin adjacent to the first edge of the base wherein the at least one guide pin is placed to retain the notepad in cooperation with the stop.

2) The notepad holder of claim 1 wherein at least one edge of the notepad is grooved to accommodate the at least one guide pin.

3) The notepad holder of claim 1 further comprising at least one additional guide pin.

4) The notepad holder of claim 1 wherein the stop comprises one or more additional guide pins.

5) The notepad holder of claim 1 wherein there the stop and the at least one guide pins are placed to correspond to the top and bottom of the notepad.

6) The notepad holder of claim 1 wherein there are two or more guide pins wherein said guide pins are formed as part of single element.

7) The notepad holder of claim 6 wherein the single element forming two or more guide pins is U-shaped.

8) The notepad holder of claim 7 wherein an edge of the notepad is grooved to accommodate the guide pins.

9) The notepad holder of claim 8 wherein the stop comprises one or more additional guide pins.

10) The notepad holder of claim 9 further comprising one or more additional guide pins wherein said guide pins are formed from a single element.

11) The notepad holder of claim 10 wherein the single element is U-shaped.
